(19) United States
(12) Patent Application Publication
(10) Pub. No.: US 2014/0107905 A1
(43) Pub. Date: Apr. 17, 2014

(54) METHOD FOR DIAGNOSING A SUPERCHARGING SYSTEM OF INTERNAL COMBUSTION ENGINES

(71) Applicant: Uwe Kassner, Moeglingen (DE)

(72) Inventor: Uwe Kassner, Moeglingen (DE)

(21) Appl. No.: 14/110,632

(22) PCT Filed: Feb. 22, 2012
(86) PCT No.: PCT/EP12/52995

§ 371 Date: Dec. 16, 2013

(30) Foreign Application Priority Data
Apr. 8, 2011 (DE) 10 2011 007 031.1

(51) Int. Cl. F02D 45/00

(52) U.S. Cl. CPC F02D 45/00
USPC 701/101

(57) ABSTRACT

A method for diagnosing a forced induction system is described, in which by measured data acquisition the frequency spectrum generated upon rotation of the forced induction system is acquired, and by measured data evaluation the acquired frequency spectrum is evaluated using frequency analysis. A frequency characteristic of the forced induction system, ascertained by frequency analysis, for at least one predefined operating point of the forced induction system is compared with a predefined vehicle-specific frequency characteristic of the forced induction system for the at least one predefined operating point.

### CROSS REFERENCE TO RELATED APPLICATION

The present application is the national stage entry of International Patent Application No. PCT/EP2012/052995, filed on Feb. 22, 2012, which claims priority to Application No. DE 10 2011 007 031.1, filed in the Federal Republic of Germany on . 8, 2011.

### FIELD OF INVENTION

The present invention relates to a method for diagnosing a forced induction system of internal combustion engines.

### BACKGROUND INFORMATION

Internal combustion engines of motor vehicles are increasingly being equipped with forced induction systems, for example exhaust gas turbochargers that utilize the energy contained in the exhaust gas flow to achieve a cylinder charge of fresh gas that is increased as compared with normally aspirated engine operation. The subassembly of such forced induction systems on the internal combustion engine is very complex, since little installation space is available and the gas and intake side of the internal combustion engine must be incorporated. In addition to the exhaust gas turbocharger, actuators for regulating the forced induction must also be accommodated. This compactness makes repair work difficult, and the presence of small installation spaces complicates access to the components and thus the recognition of faults and replacement of parts of the forced induction system for fault isolation.

German Application No. DE 198 18 124 describes integrating an onboard diagnostic function for an exhaust gas turbocharger into the engine controller. Provision is made for that purpose to determine the rotation speed of the turbocharger using a knock sensor mounted on the exhaust gas turbocharger, and to ascertain the rotation speed of the turbocharger from a frequency analysis of the frequency signal of the knock sensor. An additional complicating factor is that in repair shops it is not possible to operate the internal combustion engine in different operating states, as is possible on a roller test stand during vehicle development.

A further method for diagnosing an exhaust gas turbocharger that can be used in repair shops is described in European Application No. EP 680611, in which the rotation speed of the exhaust gas turbocharger is ascertained by the fact that the noise generated by the rotation of the turbocharger is recorded by a microphone, evaluated by frequency analysis, and the rotation speed of the exhaust gas turbocharger is inferred on the basis of the frequency analysis. In this context, the internal combustion engine is operated over the entire rotation speed range, and the rotation speed of the exhaust gas turbocharger is inferred by frequency analysis. This method requires that the vehicle be operated through the various operating states on a roller test stand.

### SUMMARY

The method according to the present invention has an advantage that by comparing a frequency characteristic of the forced induction system, ascertained by frequency analysis, for at least one predefined operating point of the forced induction system with a predefined vehicle-specific frequency characteristic of the forced induction system for the at least one predefined operating point of the forced induction system, rapid and reliable diagnosis of the forced induction system of the motor vehicle is possible. The method can thereby be easily put into practice by the fact that diagnostic devices present in repair shops can be used, and need only to be supplemented with additional algorithms for exhaust gas turbocharger diagnosis as a software version. Using the measurement data that are sensed, the rotation speed of multiple components of the forced induction system can also be determined.

The method is put into practice by ascertaining an actual rotation speed of the forced induction system from the ascertained frequency characteristic for the predefined operating point, and comparing the ascertained actual rotation speed with a predefined vehicle-specific target rotation speed of the forced induction system of the motor vehicle which characterizes that operating point. Lastly, the functionality of the forced induction system is inferred on the basis of a comparison of the actual rotation speed of the forced induction system with the target rotation speed of the forced induction system.

Diagnosis of the forced induction system can also be effected in simple fashion by the fact that measured data acquisition for acquisition of the frequency spectrum of the forced induction system occurs for at least one predefined operating point of the forced induction system during a predefined driving profile of the motor vehicle. Measured data acquisition for acquisition of the frequency spectrum of the forced induction system can be accomplished during the predefined driving profile by driving the motor vehicle. As a result, the motor vehicle can be driven on a normal road for measured data acquisition, so that the method can be carried out by any repair shop independently of roller test stands.

The evaluation of measured data is not limited only to acquisition of the rotation speed of the exhaust gas turbocharger, but can also be employed for signal components not contained in the comparison signal in order to recognize damage to the exhaust gas turbocharger. In a further evaluation of the frequency spectrum, for example, it is possible to analyze whether further frequencies that are not present within reference measurements of the vehicle manufacturer exist in the frequency spectrum, by scanning the frequency spectrum for further atypical frequencies and inferring damage to the forced induction system from the presence of atypical frequencies.

In an additional evaluation, the amplitudes of the individual discrete frequencies can be compared with limit values. For this, the ascertained frequency spectrum is subjected to an amplitude evaluation so that a noise diagnosis of the forced induction system can be carried out on the basis of the amplitude evaluation.

An exemplifying embodiment of the present invention is described in more detail in the following with reference to the accompanying drawings.

### BRIEF DESCRIPTION OF THE DRAWINGS

FIG. 1 is a block diagram for carrying out the method according to the present invention.

FIG. 2 shows a signal of an exhaust gas turbocharger received from a sensor.

FIG. 3 shows a frequency spectrum from FIG. 2, ascertained by frequency analysis.

FIG. 4 is a block diagram of measured data evaluation.

### DETAILED DESCRIPTION

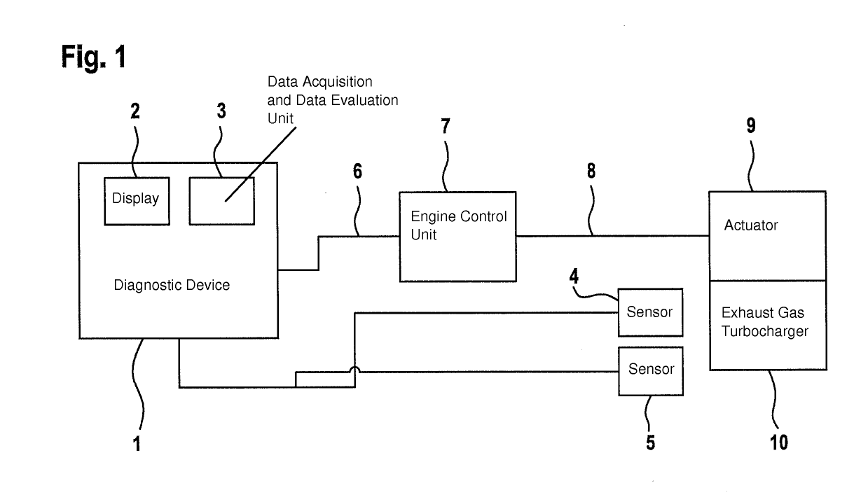

FIG. 1 describes the overall configuration of a diagnosis system of a forced induction system of a motor vehicle, for example of an exhaust gas turbocharger. A mobile diagnostic device 1 that is usually used in repair shops for the diagnosis of motor vehicles can be utilized for this. Diagnostic device 1 has at least one display 2 and a data acquisition and evaluation unit 3. Diagnostic devices 1 of this kind are established art, so that diagnosis of the exhaust gas turbocharger can be carried out with the usual diagnostic device 1. Diagnostic device 1 simply needs to be supplemented with an additional algorithm for exhaust gas turbocharger diagnosis as a software version.

The diagnosis system for exhaust gas turbochargers encompasses at least one sensor for detecting a frequency spectrum emitted by the exhaust gas turbocharger upon rotation. The diagnosis system according to FIG. 1 preferably has two sensors 4 and 5 that are associated with an exhaust gas turbocharger 10 of a motor vehicle. A microphone for detecting the airborne sound of exhaust gas turbocharger 10 is labeled 4, for example, and a vibration sensor for detecting the vibration or solid-borne sound of exhaust gas turbocharger 10 is labeled 5, for example. For diagnosis, sensors 4 and 5 are mounted by way of a universal or vehicle-specific clamping apparatus in the vicinity of exhaust gas turbocharger in and/or on the motor vehicle, so that the motor vehicle can be driven on the road. Either sensor 4 or sensor 5 can be used, in vehicle-specific fashion; simultaneous utilization is also possible. When vibration sensors are used to evaluate the solid-borne sound of exhaust gas turbocharger 10, the sensor can be mounted, for example, on the housing of the exhaust gas turbocharger using an adhesive film. Piezoelectric sensors or, for example, also micromechanical acceleration sensors, as in an ABS/ESP system, can be used as vibration sensors. It is advantageous in this context if the vehicle manufacturer stipulates in the repair shop documentation an installation location for sensors 4 and 5, as is already done for repair shop diagnosis using special tools and diagnostic aids.

The diagnosis system further encompasses a data lead 6 that is constituted as a diagnostic cable known per se. Data lead 6 connects diagnostic device 1 to an engine control unit 7 present in the motor vehicle, which unit is in turn connected via a control lead 8 to an actuator 9. By way of actuator 9, exhaust gas turbocharger 10 in the motor vehicle is controlled by engine control device 7 as a function of operating state.

The diagnostic method for the exhaust gas turbocharger is accomplished in two steps, namely measured data acquisition and measured data evaluation. In the first step (measured data acquisition) a driving profile having predetermined operating points A, B for exhaust gas turbocharger 10, for example the gear ratio to be selected and the speed to be driven, is stipulated to the driver of the motor vehicle, for example, for driving on the road. Operating points A, B are to be defined in vehicle-model-specific fashion, and cover specific operating modes of exhaust gas turbocharger 10. The measured values of sensors 4, 5 and data regarding operating points A, B of exhaust gas turbocharger 10, which are taken from engine control unit 7, are stored in data acquisition and data evaluation unit 3. For this, as the driving profile is being carried out diagnostic device 1 is connected to engine control unit 7 via data lead 6 during measured data acquisition. Diagnostic device 1 further informs the driver, for example by way of display 2, when a sufficient measurement time for the particular operating point has been reached. Once all the operating points have been sufficiently acquired, measured data acquisition is terminated. A few minutes of testing time in total are required, so that the above-described simple mounts for sensors 4, 5, which do not need to be permanently suitable for all kinds of driving situations, can be removed again.

It is likewise evident from this that the requirements regarding the temperature resistance of sensors 4, 5 are much less stringent than for production use on an exhaust gas turbocharger.

During measured data acquisition, diagnostic device 1 also authorizes variable application of control to actuator 9 via engine controller 7. From the varying rotation speed of exhaust gas turbocharger 10 that is determined in the subsequent second step of measured data evaluation, it is additionally possible to infer the functionality of actuator 9.

It is known that during operation, exhaust gas turbochargers 10 generate sound and vibrations at various frequencies. The frequencies occurring in this context represent harmonic fundamental frequencies that are sensed as a frequency spectrum of exhaust gas turbocharger 10. For this, data acquisition and evaluation unit 3 contains, for measured data evaluation, means known per se for frequency analysis of the detected frequency spectrum.

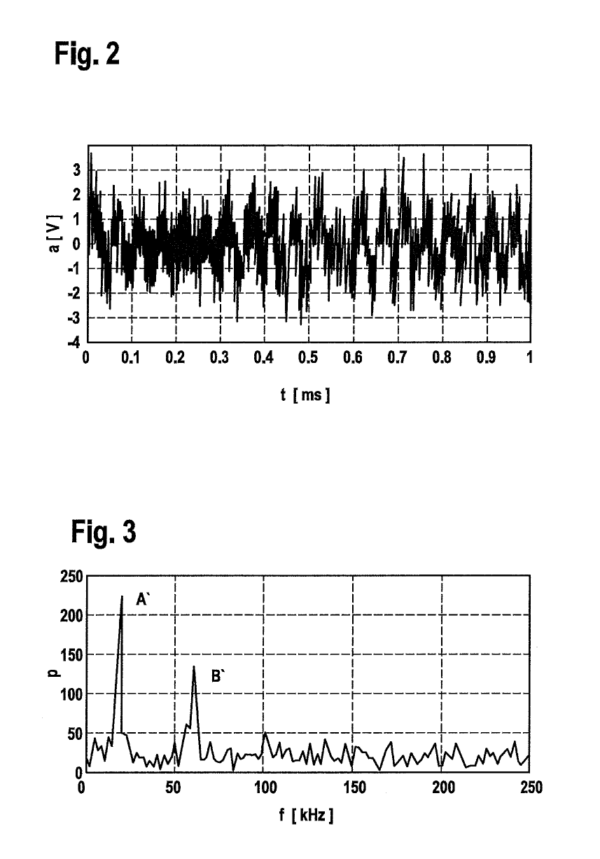

In the context of measured data acquisition, a signal profile is detected by sensors 4, 5. FIG. 2 shows an example of such a signal profile as a function of time, measured using a microphone as sensor 4. In the context of the measured data evaluation carried out in the second step subsequently to measured data acquisition, the frequency spectrum of FIG. 2 is evaluated by way of the aforesaid frequency analysis, e.g., by Fourier analysis, by the fact that a frequency characteristic as depicted in FIG. 3 is ascertained for the predefined operating point or points A, B. The frequency spectrum of FIG. 2 evaluated by frequency analysis shows, in FIG. 3, two typical frequency peaks A′, B′ at, for example, 20 and 60 kHz, which characterize the two predefined operating points A and B. In addition, a predefined vehicle-specific frequency characteristic for the predefined operating points A and B is stored in diagnostic device 1 or in engine control unit 7. The predefined vehicle-specific frequency characteristic at the predefined operating points A, B is provided, for example, by the vehicle manufacturer. In a further step, the frequency characteristic according to FIG. 3 ascertained for the predefined operating points A, B is then compared with the predefined vehicle-specific frequency characteristic at those predefined operating points A, B. The rotation speed of exhaust gas turbocharger 10 at the predefined operating points A, B is determined on the basis of the comparison. If a discrepancy exists, exhaust gas turbocharger 10 is not operating correctly. The comparison can be performed by data acquisition and evaluation unit 3 of diagnostic device 1 or by engine control unit 7.

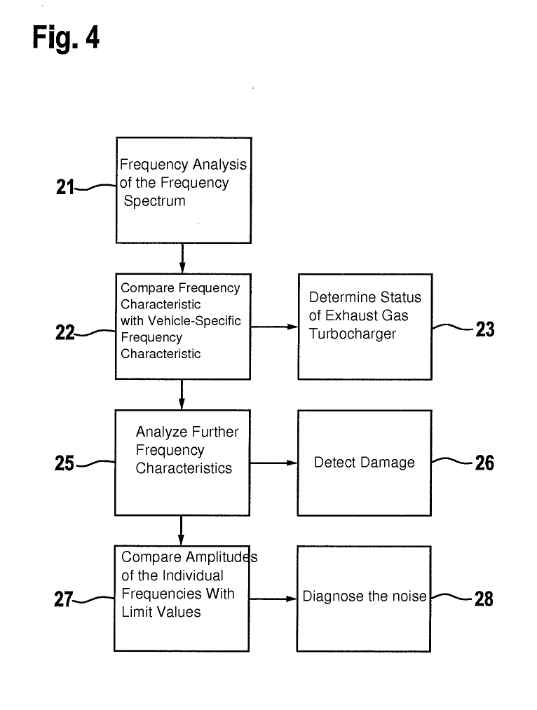

A more detailed measured data evaluation sequence is depicted in FIG. 4. In step 21, as already mentioned, a frequency analysis of the frequency spectrum, previously detected in the context of measured data acquisition, for the at least one predefined operating points A, B of exhaust gas turbocharger 10 is carried out. In step 22 a frequency evaluation is accomplished by comparing the frequency characteristic present for the predefined operating point A, B with the predefined vehicle-specific frequency characteristic at the predefined operating point. In step 23, the actual rotation speed of exhaust gas turbocharger 10 determined at operating points A, B is compared with the vehicle-specific target rotation speed of exhaust gas turbocharger 10 predefined by the vehicle manufacturer for those operating points A, B. The status of exhaust gas turbocharger 10 is inferred by way of the comparison. If a discrepancy exists between the actual rotation speed and the target rotation speed, exhaust gas turbocharger 10 is not operating correctly.

A further evaluation in accordance with step 25 analyzes whether further frequency characteristics that deviate from a frequency characteristic previously ascertained by way of a reference measurement by the vehicle manufacturer are present in the detected frequency spectrum. In the case of a discrepancy between the ascertained and the predefined frequency characteristic, in step 26 damage is detected that, for example, is not yet perceptibly influencing the functionality of the exhaust gas turbocharger (e.g., damage to individual compressor blades or turbine blades).

In an additional evaluation in accordance with step 27, the amplitudes of the individual discrete frequencies are compared with limit values. In step 28, noise is diagnosed on the basis of the amplitude comparison. The noise diagnosis allows objectivization of customer complaints regarding noises from exhaust gas turbocharger 10 that have not yet been objectively evaluated in the repair shop.

1-8. (canceled)

9. A method for diagnosing a forced induction system of an internal combustion engine, comprising:
acquiring by measured data acquisition a frequency spectrum generated by the forced induction system,
evaluating by measured data evaluation the acquired frequency spectrum using frequency analysis, and
comparing a frequency characteristic of the forced induction system, ascertained by frequency analysis, for at least one predefined operating point of the forced induction system with a predefined vehicle-specific frequency characteristic of the forced induction system for the at least one operating point of the forced induction system.

10. The method according to claim 9, wherein an actual rotation speed of the forced induction system is ascertained from the ascertained frequency characteristic at the predefined operating point; and the ascertained actual rotation speed is compared with a predefined vehicle-specific target rotation speed of the forced induction system which characterizes the predefined operating point.

11. The method according to claim 10, further comprising:
inferring a functionality of the forced induction system on the basis of the comparison of the actual rotation speed of the forced induction system with the target rotation speed of the forced induction system.

12. The method according to claim 9, wherein noise and/or vibrations generated by the forced induction system are acquired in the context of the measured data acquisition for detection of the frequency spectrum.

13. The method according to claim 9, wherein the measured data acquisition for acquisition of the frequency spectrum of the forced induction system is accomplished during a predefined driving profile of a motor vehicle.

14. The method according to claim 13, wherein the measured data acquisition for acquisition of the frequency spectrum of the forced induction system is accomplished during the predefined driving profile while driving the motor vehicle.

15. The method according to claim 9, further comprising:
scanning the frequency characteristic for further atypical frequencies; and
inferring damage to the forced induction system from a presence of atypical frequencies.

16. The method according to claim 9, further comprising:
subjecting the ascertained frequency characteristic to an amplitude evaluation; and
performing a noise diagnosis of the forced induction system on the basis of the amplitude evaluation.
